(19) United States
(12) Patent Application Publication
(10) Pub. No.: US 2012/0242655 A1
(43) Pub. Date: Sep. 27, 2012

(54) IMAGE PROCESSING APPARATUS, IMAGE PROCESSING METHOD, AND PROGRAM

(76) Inventors: Masami Ogata, Kanagawa (JP); Takafumi Morifuji, Tokyo (JP); Suguru Ushiki, Tokyo (JP)

(21) Appl. No.: 13/354,727

(22) Filed: Jan. 20, 2012

(30) Foreign Application Priority Data
Mar. 23, 2011 (JP) 2011-064511

(51) Int. Cl. G06T 15/00

(52) U.S. Cl. 345/419

(57) ABSTRACT

A method, apparatus, and computer-readable storage medium for adjusting display of a three-dimensional image is provided. The method includes receiving a viewing condition associated with an image being viewed by a user, determining, by a processor, a conversion characteristic based on the viewing condition, adjusting, by the processor, a display condition of the image based on the conversion characteristic.

### CROSS-REFERENCE TO RELATED APPLICATION

This application claims priority of Japanese Patent Application No. 2011-064511, filed on Mar. 23, 2011, the entire content of which is hereby incorporated by reference.

### BACKGROUND

The present disclosure relates to an image processing apparatus, an image processing method, and a program, and more particularly to, an image processing apparatus, an image processing method, and a program capable of obtaining a more appropriate sense of depth irrespective of viewing conditions of a stereoscopic image.

Hitherto, there have been techniques for displaying a stereoscopic image by display apparatuses. A sense of depth of a subject reproduced by the stereoscopic image is changed by viewing conditions in which users view the stereoscopic image or viewing conditions which are determined by physical features such as a pupillary distance of a user. Accordingly, in some cases, the reproduced sense of depth may not be suitable for the user, thereby causing the user to feel fatigue.

For example, when an actual view distance of a stereoscopic image generated on the assumption of a specific view distance or the display size is closer than an assumed distance and the size of a screen of a display apparatus displaying the stereoscopic image is greater than the size of an assumed display apparatus, it is difficult to view the stereoscopic image. Accordingly, there has been suggested a technique for controlling a parallax of a stereoscopic image by the use of cross-point information added to the stereoscopic image (for example, see Japanese Patent No. 3978392).

In the above-mentioned technique, however, the sufficiently appropriate sense of depth may not necessarily be provided for every user in accordance with viewing conditions in some cases. In the technique using the cross-point information, it may be difficult to control the parallax of the stereoscopic image when the cross-point information is not added to the stereoscopic image.

It is desirable to provide a technique for obtaining a more appropriate sense of depth irrespective of viewing conditions of a stereoscopic image.

According to the embodiments of the present disclosure, it is possible to obtain the more appropriate sense of depth irrespective of the viewing conditions of the stereoscopic image.

### SUMMARY

Accordingly, there is provided a computer-implemented method for adjusting display of a three-dimensional image. The method may include receiving a viewing condition associated with an image being viewed by a user; determining, by a processor, a conversion characteristic based on the viewing condition; and adjusting, by the processor, a display condition of the image based on the conversion characteristic.

In accordance with an embodiment, there is provided an apparatus for adjusting display of a three-dimensional image. The apparatus may include a display device for displaying an image for viewing by a user; a memory storing the instructions; and a processor executing the instructions to receive a viewing condition associated with the image; determine a conversion characteristic based on the viewing condition; and adjust a display condition of the image based on the conversion characteristic.

In accordance with an embodiment, there is provided a non-transitory computer-readable storage medium comprising instructions, which when executed on a processor, cause the processor to perform a method for adjusting display of a three-dimensional image. The method may include receiving a viewing condition associated with an image being viewed by a user; determining a conversion characteristic based on the viewing condition; and adjusting a display condition of the image based on the conversion characteristic.

### BRIEF DESCRIPTION OF THE DRAWINGS

FIG. 1 is a diagram illustrating a pupillary distance and the depth of a stereoscopic image;

FIG. 2 is a diagram illustrating a relationship between a parallax of the pupillary distance and a view distance;

FIG. 3 is a diagram illustrating a display size and the depth of a stereoscopic image;

FIG. 4 is a diagram illustrating the view distance and the depth of the stereoscopic image;

FIG. 5 is a diagram illustrating an allowable nearest position and an allowable farthest position;

FIG. 6 is a diagram illustrating an allowable minimum parallax and an allowable maximum parallax;

FIG. 7 is a diagram illustrating an example of the configuration of a stereoscopic image display system according to an embodiment;

FIG. 8 is a diagram illustrating an example of the configuration of a parallax conversion apparatus;

FIG. 9 is a flowchart illustrating an image conversion process;

FIG. 10 is a diagram illustrating detection of the minimum parallax and the maximum parallax in a cumulative frequency distribution;

FIG. 11 is a diagram illustrating an example of conversion characteristics;

FIG. 12 is a diagram illustrating an example of conversion characteristics;

FIG. 13 is a diagram illustrating an example of conversion characteristics;

FIG. 14 is a diagram illustrating an example of a lookup table;

FIG. 15 is a diagram illustrating image synthesis;

FIG. 16 is a diagram illustrating another example of the configuration of the stereoscopic image display system;

FIG. 17 is a diagram illustrating an example of the configuration of a parallax conversion apparatus;

FIG. 18 is a flowchart illustrating an image conversion process;

FIG. 19 is a diagram illustrating calculation of the pupillary distance;

FIG. 20 is a diagram illustrating still another example of the configuration of the stereoscopic image display system;

FIG. 21 is a diagram illustrating an example of the configuration of a parallax conversion apparatus;

FIG. 22 is a flowchart illustrating an image conversion process; and

FIG. 23 is a diagram illustrating an example of the configuration of a computer.

### DETAILED DESCRIPTION OF EMBODIMENTS

Hereinafter, embodiments to which the present technique is applied will be described with reference to the drawings.

### First Embodiment

### Viewing conditions and Sense of Depth of Stereoscopic Image

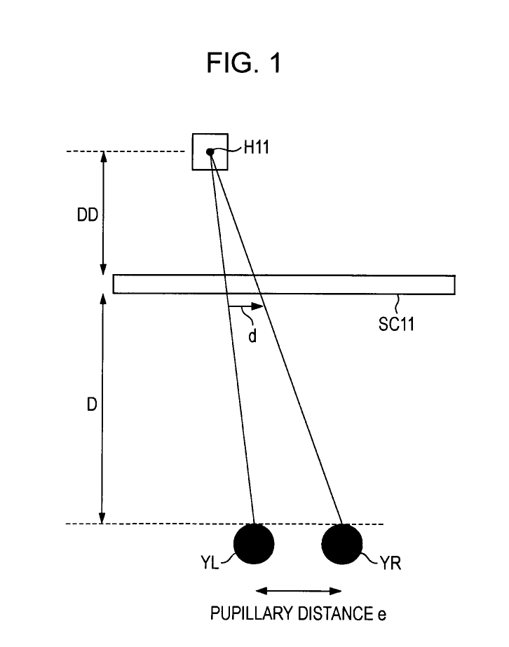

First, viewing conditions of users watching a stereoscopic image and a sense of depth of the stereoscopic image will be described with reference to FIGS. 1 to 4.

As shown in FIG. 1, it is assumed that a stereoscopic image formed by a right-eye image and a left-eye image is displayed on a display screen SC11 and a user watches the stereoscopic image distant from the display screen SC11 only at a view distance D. Here, the right-eye image forming the stereoscopic image is an image displayed, so that the user can watch the right-eye image with his or her right eye when the stereoscopic image is displayed. The left-eye image forming the stereoscopic image is an image displayed, so that the user can watch the left-eye image with his or her left eye when the stereoscopic image is displayed.

Here, it is assumed that e (hereinafter, referred to as a pupillary distance e) is a distance between a right eye YR and a left eye YL and d is a parallax of a predetermined subject H11 in the right-eye and left-eye images. That is, d is the distance between the subject H11 on the left-eye image and the subject H11 on the right-eye subject on the display screen SC11.

In this case, the position of the subject H11 perceived by the user, that is, the localization position of the subject H11 is distant from the display screen SC11 by a distance DD (hereinafter, referred to a depth distance DD). The depth distance DD is calculated by Expression (1) below from the parallax d, the pupillary distance e, and the view distance D.

Depth Distance DD=d×D/(e−d) (1)

In this expression, the parallax d has a positive value when the subject H11 on the right-eye image on the display screen SC11 is present on the right side of the subject H11 on the left-eye image in the drawing, that is, is present on the right side from the user viewing the stereoscopic image. In this case, the depth distance DD has a positive value and the subject H11 is localized on the rear side of the display screen SC11 when viewed from the user.

On the contrary, the parallax d has a negative value when the subject H11 on the right-eye image on the display screen SC11 is present on the left side of the subject H11 in the drawing. In this case, since the depth distance DD has a negative value, the subject H11 is localized on the front side of the display screen SC11 when viewed from the user.

The pupillary distance e is different depending on users viewing the stereoscopic image. For example, the general both-eye distance e of adults is about 6.5 cm, while the general both-eye distance e of children is about 5 cm.

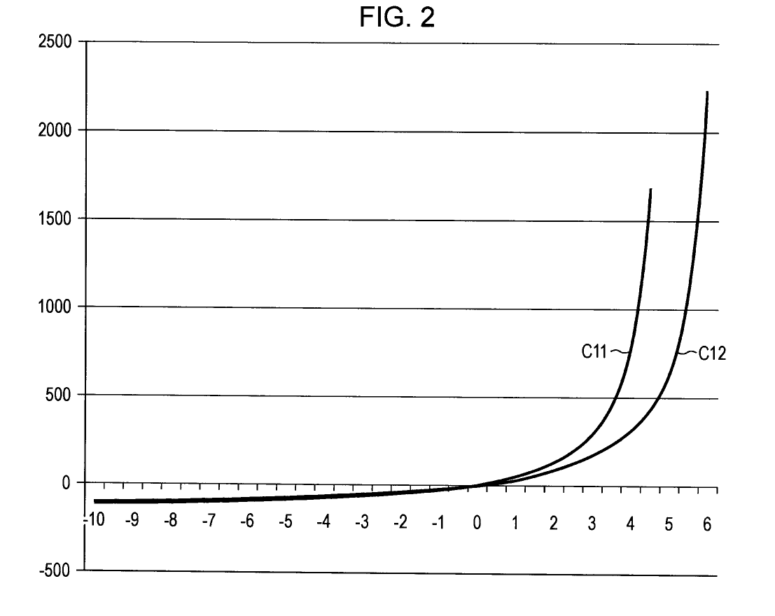

Therefore, as shown in FIG. 2, the depth distance DD relative to the parallax d of the stereoscopic image varies in accordance with the pupillary distance e. In the drawing, the vertical axis represents the depth distance DD and the horizontal axis represents the parallax d. A curve C11 is a curve indicating the depth distance DD relative to the parallax d when the pupillary distance e=5 cm. A curve C12 is a curve indicating the depth distance DD relative to the parallax d when the pupillary distance e=6.5 cm.

As understood from the curves C11 and C12, the larger the parallax d is, the larger a distance between the depth distances DD shown in the curves C11 and C12 is. Accordingly, in the stereoscopic image adjusted in the parallax for adults, the burden is increased for children when the parallax d is larger.

Thus, since the depth distance DD varies depending on the value of the pupillary distance e of each user, it is necessary to control the parallax d for each user depending on the pupillary distance e so that the depth distance DD of each subject in the stereoscopic image becomes a distance within an appropriate range.

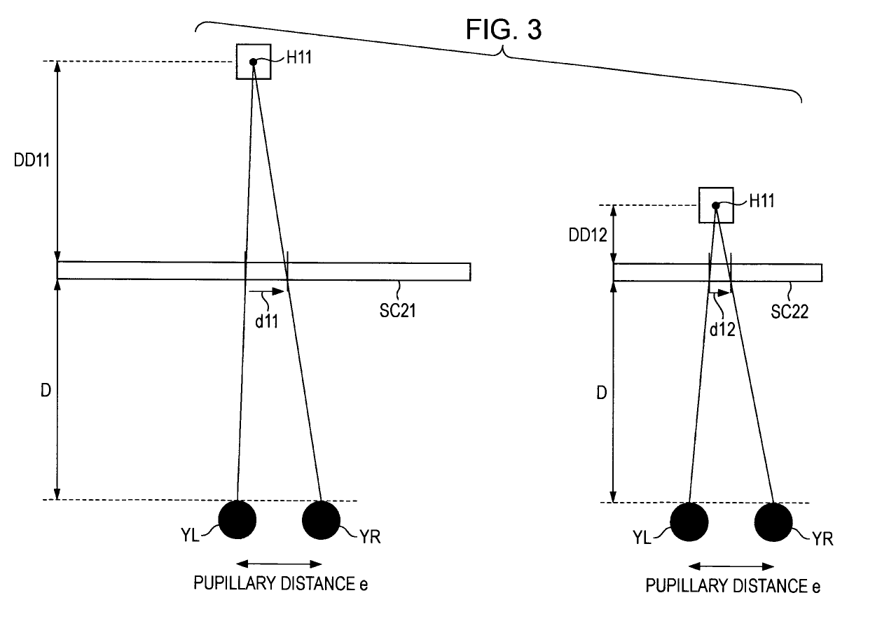

As shown in FIG. 3, when the size of the display screen on which the stereoscopic image is displayed varies in spite of the fact that the parallax between the right-eye image and the left-eye image on the stereoscopic image is the same, the size of a single pixel, that is, the size of the subject on the display screen varies, and thus the magnitude of the parallax d varies.

In the example of FIG. 3, stereoscopic images with the same parallax are displayed on a display screen SC21 shown in the left part of the drawing and a display screen SC22 shown in the right part of the drawing, respectively. However, since the display screen SC21 is larger than the display screen SC22, the parallax on the display screen is larger for the display screen SC21. That is, the parallax d=d11 is set on the display screen SC21, whereas the parallax d=d12 (where d11>d12) is set on the display screen SC22.

Thus, the depth distance DD=DD11 of the subject H11 displayed on the display screen SC21 is also greater than the depth distance DD=DD12 of the subject H11 displayed on the display screen SC22. For example, when a stereoscopic image generated for a small-sized screen such as a display screen SC22 by controlling the parallax is displayed on a large-sized screen such as the display surface SC21, the parallax is too large, thereby increasing the burden on the eyes of the user.

Thus, since the sense of depth being reproduced is different depending on the size of the display screen on which the stereoscopic image with the same parallax is displayed, it is necessary to appropriately control the parallax d in accordance with the size (display size) of the display screen on which the stereoscopic image is displayed.

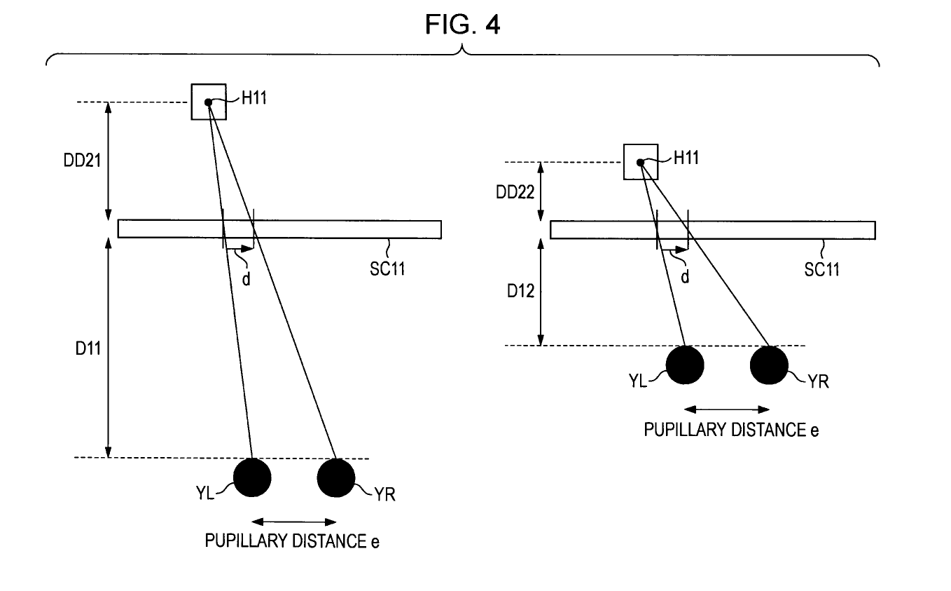

Further, even when the view distance D of the user varies in spite of the fact that the size of the display screen SC11 on which the stereoscopic image is displayed or the parallax d on the display screen SC11 is the same, for example, as shown in FIG. 4, the depth distance DD of the subject H11 varies.

In the example of FIG. 4, the size of the display screen SC11 on the right part of the drawing is the same as that of the display screen SC11 on the left part of the drawing and the subject H11 is displayed with the same parallax d on the display screens SC11. However, the view distance D=D11 on the left part of the drawing is greater than the view distance D=D12 on the right part of the drawing.

Thus, the depth distance DD=DD21 of the subject H11 on the left part of the drawing is also greater than the depth distance DD=DD22 of the subject H11 on the right part of the drawing. Accordingly, for example, when the view distance of the user is too short, a convergence angle at which the subject H11 is viewed is larger. For this reason, it is harder to view the stereoscopic image in some cases.

In this way, since the sense of depth being reproduced also varies depending on the view distance D of the user, it is necessary to appropriately control the parallax d in accordance with the view distance D between the user to the display screen.

It is necessary to appropriately convert the parallax d in accordance with the pupillary distance e, the size of the display screen on which the stereoscopic image is displayed, and the view distance D so that the depth distance DD of each subject on the stereoscopic image becomes a distance within an appropriate range in which burden is lower for the user.

Hereinafter, the size of the display screen on which the stereoscopic image is displayed, particularly, the length of the display screen in a parallax direction is referred to as a display width W. Moreover, conditions associated with the viewing of the stereoscopic image of the user determined by at least the pupillary distance e, the display width W, and the view distance D are referred to as viewing conditions.

### Appropriate Parallax of Stereoscopic Image

Next, the range of an appropriate parallax of a stereoscopic image determined under the above-described viewing conditions will be described.

It is assumed that the minimum value and the maximum value of the parallax within the range of the appropriate parallax of the stereoscopic image determined under the viewing conditions are referred to as a parallax dₘᵢₙ′ and a parallax dₘₐₓ′, respectively, and the parallax dₘᵢₙ′ and the parallax dₘₐₓ′ are calculated from the pupillary distance e, the display width W, and the view distance D as the viewing conditions.

Here, the parallax dₘᵢₙ′ and the parallax dₘₐₓ′ are a parallax set by using pixels on the stereoscopic image as a unit. That is, the parallax dₘᵢₙ′ and the parallax dₘₐₓ′ are a parallax of a pixel unit between the right-eye image and the left-eye image forming the stereoscopic image.

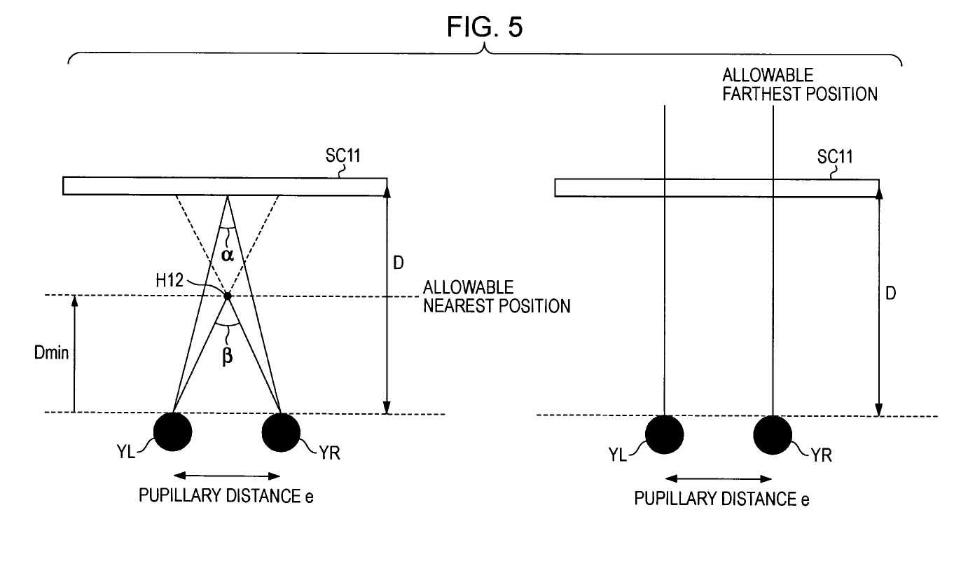

As shown in the left part of FIG. 5, it is assumed that the localization position of the subject H12 of which the parallax is the parallax dₘᵢₙ′ among the subjects on the stereoscopic image is an allowable nearest position and the distance between the user and the allowable nearest position is an allowable nearest distance Dₘᵢₙ. Further, as shown on the right part of the drawing, it is assumed that the localization position of the subject of which the parallax is the parallax dₘₐₓ′ is an allowable farthest position and the distance between the user and the allowable farthest position is an allowable farthest distance Dₘₐₓ.

That is, the allowable nearest distance Dₘᵢₙ is the minimum value of the distance, which is allowed for the user to view the stereoscopic image with an appropriate parallax, between both the eyes (the left eye YL and the right eye YR) of the user and the localization position of the subject on the stereoscopic image. Likewise, the allowable farthest distance Dₘₐₓ is the maximum value of the distance, which is allowed for the user to view the stereoscopic image with an appropriate parallax, between both the eyes of the user and the localization position of the subject on the stereoscopic image.

For example, as shown in the left part of the drawing, an angle at which the user views the display screen SC11 with the left eye YL and the right eye YR is set to an angle α and an angle at which the user views the subject H12 is set to angle β. In general, the subject H12 with the maximum angle β satisfying a relation of β−α≦60′ is considered as a subject located at the allowable nearest position.

As shown in the right part of the drawing, the distance between both the eyes of the user to a subject located at an infinite position is considered as the allowable farthest distance Dₘₐₓ. In this case, the visual lines of both the eyes of the user viewing the subject located at the position of the allowable farthest distance Dₘₐₓ are parallel to each other.

The allowable nearest distance Dₘᵢₙ and the allowable farthest distance Dₘₐₓ can be geometrically calculated from the pupillary distance e and the view distance D.

That is, Expression (2) below is satisfied from the pupillary distance e and the view distance D.

tan(α/2)=(1/D)×(e/2) (2)

When Expression (2) is modified, the angle α is calculated as expressed in Expression (3).

α=2 tan⁻¹(e/2D) (3)

The angle β is expressed in Expression (4) below, as in the angle α.

β=2 tan⁻¹(e/2Dₘᵢₙ) (4)

The angle β for viewing the subject H12 located from the user only by the allowable nearest distance Dₘᵢₙ satisfies Expression (5) below, as described. Therefore, the allowable nearest distance Dₘᵢₙ satisfies the condition expressed Expression (6) from Expression (4) and Expression (5).

β−α≦60 (5)

allowable nearest distance Dₘᵢₙ≧e/2 tan((60+α)/2) (6)

When Expression (3) is used to substitute α of Expression (6) obtained in this way, the allowable nearest distance Dₘᵢₙ can be obtained. That is, the allowable nearest distance Dₘᵢₙ can be calculated when the pupillary distance e and the view distance D can be known among the viewing conditions. Likewise, when the angle α is 0 in Expression (6), the allowable farthest distance Dₘₐₓ can be obtained.

The parallax dₘᵢₙ′ and the parallax dₘₐₓ′ are calculated from the allowable nearest distance Dₘᵢₙ and the allowable farthest distance Dₘₐₓ obtained in this way.

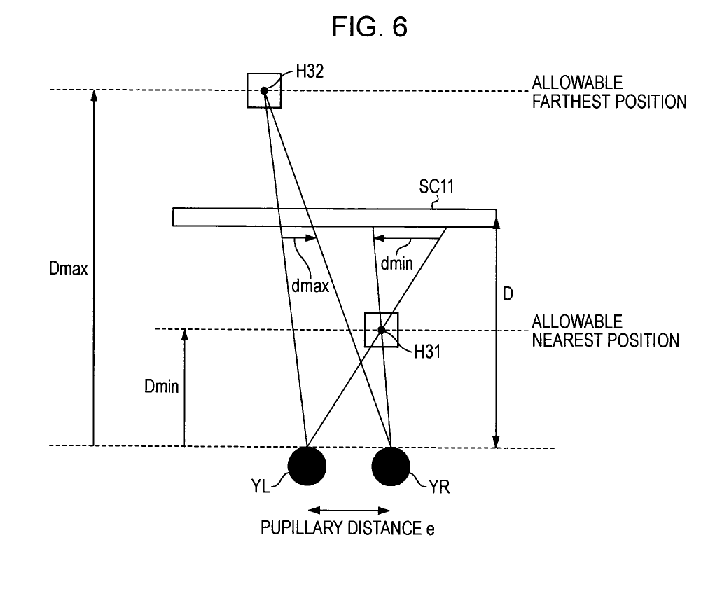

For example, as shown in FIG. 6, when a stereoscopic image is displayed on the display screen SC11, a subject H31 is localized at the allowable nearest position at which the distance from the user is the allowable farthest distance Dₘᵢₙ and a subject H32 is localized at the allowable farthest position at which the distance from the user is the allowable farthest distance Dₘₐₓ.

At this time, the parallax dₘᵢₙ of the subject H31 on the stereoscopic image on the display screen SC11 is expressed by Expression (7) below using the view distance D, the pupillary distance e, and the allowable nearest distance Dₘᵢₙ.

dₘᵢₙ=e(Dₘᵢₙ−D)/Dₘᵢₙ (7)

Likewise, the parallax dₘₐₓ of the subject H32 on the stereoscopic image on the display screen SC11 is expressed by Expression (8) below using the view distance D, the pupillary distance e, and the allowable farthest distance Dₘₐₓ.

dₘₐₓ=e(Dₘₐₓ−D)Dₘₐₓ (8)

Here, since the allowable nearest distance Dₘᵢₙ and the allowable farthest distance Dₘₐₓ are calculated from the pupillary distance e and the view distance D, as understood from Expression (7) and Expression (8), the parallax dₘᵢₙ and the parallax dₘₐₓ are also calculated from the pupillary distance e and the view distance D.

Here, the parallax dₘᵢₙ and the parallax dₘₐₓ are the distances on the display screen SC11. Therefore, in order to convert the stereoscopic image to an image with an appropriate parallax, it is necessary to convert the parallax dₘᵢₙ and the parallax dₘₐₓ into the parallax dₘᵢₙ′ and the parallax dₘₐₓ′ set by using the pixels as a unit.

When the parallax dₘᵢₙ and the parallax dₘₐₓ are expressed by the number of pixels, these parallaxes may be divided by the pixel distance of the stereoscopic image on the display screen SC11, that is, the pixel distance of a display apparatus of the display screen SC11. Here, the pixel distance of the display apparatus is calculated from the display width W and the number of pixels N in the parallax direction (a horizontal direction in the drawing) in the display apparatus, that is, the number of pixels N in the parallax direction of the stereoscopic image. The value is W/N.

The parallax dₘᵢₙ′ and the parallax dₘₐₓ′ are expressed by Expression (9) below and Expression (10) from the parallax dₘᵢₙ, the parallax dₘₐₓ, the display width W, and the number of pixels N.

parallax dₘᵢₙ′=dₘᵢₙ×N/W (9)

parallax dₘₐₓ′=dₘₐₓ×N/W (10)

The parallax dₘᵢₙ′ and the parallax dₘₐₓ′ which are the values of the appropriate parallax range of the stereoscopic image can be calculated from the pupillary distance e, the display width W, and the view distance D as the viewing conditions.

Accordingly, when the user watches the stereoscopic image under predetermined viewing conditions and the stereoscopic image input by calculating the appropriate parallax range from these viewing conditions is converted into a stereoscopic image with the parallax within the calculated parallax range and is displayed, the stereoscopic image with the appropriate sense of depth suitable for the viewing conditions can be presented.

Hitherto, the allowable nearest distance Dₘᵢₙ and the allowable farthest distance Dₘₐₓ have been described as the distances satisfying the predetermined conditions. However, the allowable nearest distance Dₘᵢₙ and the allowable farthest distance Dₘₐₓ may be set in accordance with the preference of the user.

### Example of Configuration of Stereoscopic Image Display System

Next, a stereoscopic image display system to which the present technique is applied will be described according to an embodiment.

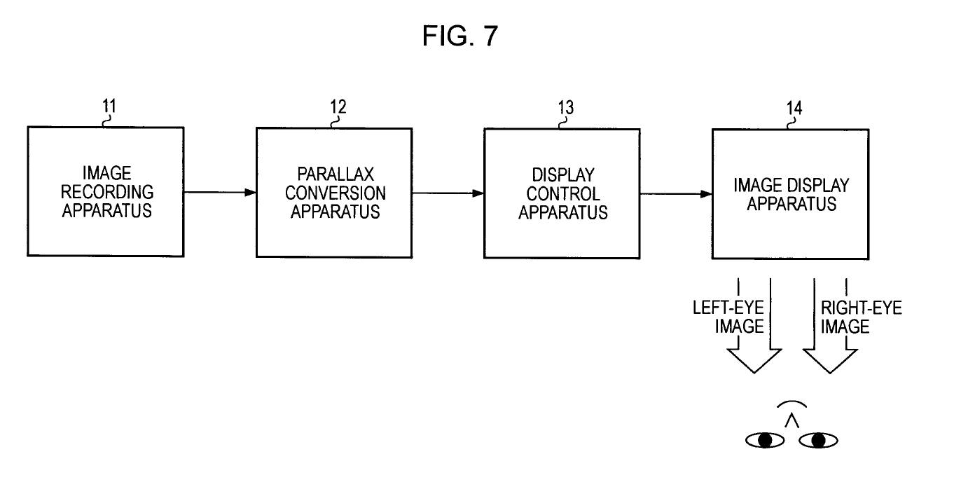

FIG. 7 is a diagram illustrating an example of the configuration of the stereoscopic image display system according to the embodiment. The stereoscopic image display system includes an image recording apparatus 11, a parallax conversion apparatus 12, a display control apparatus 13, and an image display apparatus 14.

The image recording apparatus 11 stores image data used to display a stereoscopic image. The parallax conversion apparatus 12 reads the stereoscopic image from the image recording apparatus 11, converts the parallax of the stereoscopic image in accordance with the viewing conditions of the user, and supplies the stereoscopic image with the converted parallax to the display control apparatus 13. That is, the stereoscopic image is converted into the stereoscopic image with the parallax suitable for the viewing conditions of the user.

The stereoscopic image may be a pair of still images with a parallax each other or may be a moving image with a parallax each other.

The display control apparatus 13 supplies the stereoscopic image supplied from the parallax conversion apparatus 12 to the image display apparatus 14. Then, the image display apparatus 14 stereoscopically displays the stereoscopic image supplied from the display control apparatus 13 under the control of the display control apparatus 13. For example, the image display apparatus 14 is a stereoscopic device that displays image data as a stereoscopic image. Any display method such as a lenticular lens method, a parallax barrier method, or a time-division display method can be used as a method of displaying the stereoscopic image through the image display apparatus 14.

### Example of Configuration of Parallax Conversion Apparatus

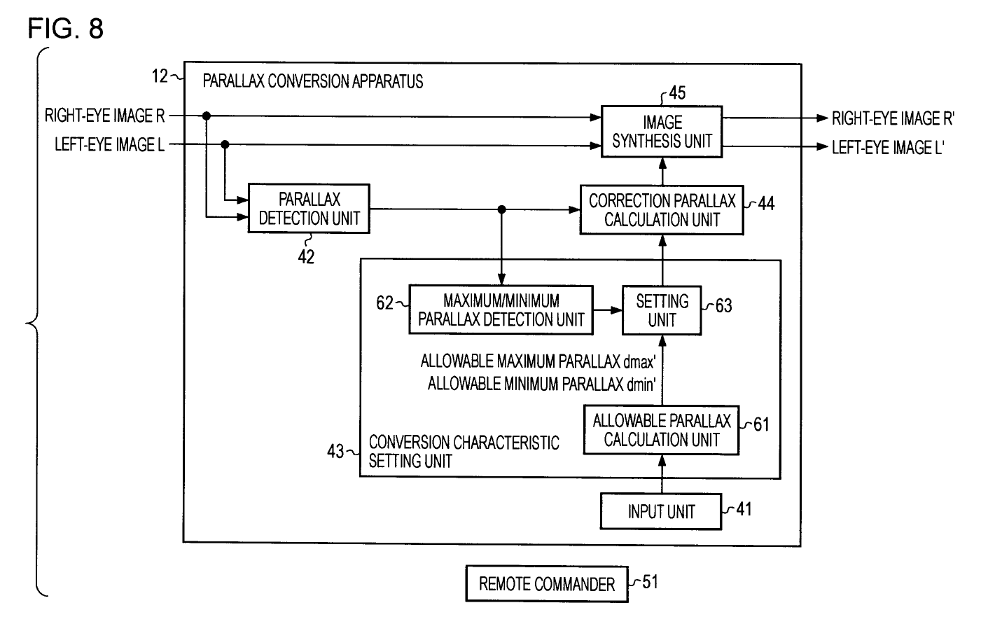

For example, the parallax conversion apparatus 12 shown in FIG. 7 has a configuration shown in FIG. 8.

The parallax conversion apparatus 12 includes an input unit 41, a parallax detection unit 42, a conversion characteristic setting unit 43, a corrected parallax calculation unit 44, and an image synthesis unit 45. In the parallax conversion apparatus 12, a stereoscopic image formed by a right-eye image R and a left-eye image L is supplied from the image recording apparatus 11 to the parallax detection unit 42 and the image synthesis unit 45.

The input unit 41 acquires the pupillary distance e, the display width W, and the view distance D as the viewing conditions and inputs the pupillary distance e, the display width W, and the view distance D to the conversion characteristic setting unit 43. For example, when a user operates a remote commander 51 to input the viewing conditions, the input unit 41 receives information regarding the viewing conditions transmitted from the remote commander 51 to obtain the viewing conditions.

The parallax detection unit 42 calculates the parallax between the right-eye image R and the left-eye image L for each pixel based on the right-eye image R and the left-eye image L supplied from the image recording apparatus 11 and supplies a parallax map indicating the parallax of each pixel to the conversion characteristic setting unit 43 and the corrected parallax calculation unit 44.

The conversion characteristic setting unit 43 determines the conversion characteristics of the parallax between the right-eye image R and the left-eye image L based on the viewing conditions supplied from the input unit 41 and the parallax map supplied from the parallax detection unit 42, and then supplies the conversion characteristics of the parallax to the corrected parallax calculation unit 44.

The conversion characteristic setting unit 43 includes an allowable parallax calculation unit 61, a maximum/minimum parallax detection unit 62, and a setting unit 63.

The allowable parallax calculation unit 61 calculates the parallax dₘᵢₙ′ and the parallax dₘₐₓ′ suitable for the characteristics of the user or the viewing conditions of the stereoscopic image based on the viewing conditions supplied from the input unit 41, and then supplies the parallax dₘᵢₙ′ and the parallax dₘₐₓ′ to the setting unit 63. Hereinafter, the parallax dₘᵢₙ′ and the parallax dₘₐₓ′ are appropriately also referred to as an allowable minimum parallax dₘᵢₙ′ and an allowable maximum parallax dₘₐₓ′, respectively.

The maximum/minimum parallax detection unit 62 detects the maximum value and the minimum value of the parallax between the right-eye image R and the left-eye image L based on the parallax map supplied from the parallax detection unit 42, and then supplies the maximum value and the minimum value of the parallax to the setting unit 63. The setting unit 63 determines the conversion characteristics of the parallax between the right-eye image R and the left-eye image L based on the parallax dₘᵢₙ′ and the parallax dₘₐₓ′ from the allowable parallax calculation unit 61 and the maximum value and the minimum value of the parallax from the maximum/minimum parallax detection unit 62, and then supplies the determined conversion characteristics to the corrected parallax calculation unit 44.

The corrected parallax calculation unit 44 converts the parallax of each pixel indicated in the parallax map into the parallax between the parallax dₘᵢₙ′ and the parallax dₘₐₓ′ based on the parallax map from the parallax detection unit 42 and the conversion characteristics from the setting unit 63, and then supplies the converted parallax to the image synthesis unit 45. That is, the corrected parallax calculation unit 44 converts (corrects) the parallax of each pixel indicated in the parallax map and supplies a corrected parallax map indicating the converted parallax of each pixel to the image synthesis unit 45.

The image synthesis unit 45 converts the right-eye image R and the left-eye image L (e.g., display condition) supplied from the image recording apparatus 11 into a right-eye image R′ and a left-eye image L′, respectively, based on the corrected parallax map supplied from the corrected parallax calculation unit 44, and then supplies the right-eye image R′ and the left-eye image L′ to the display control apparatus 13.

### Image Conversion Process

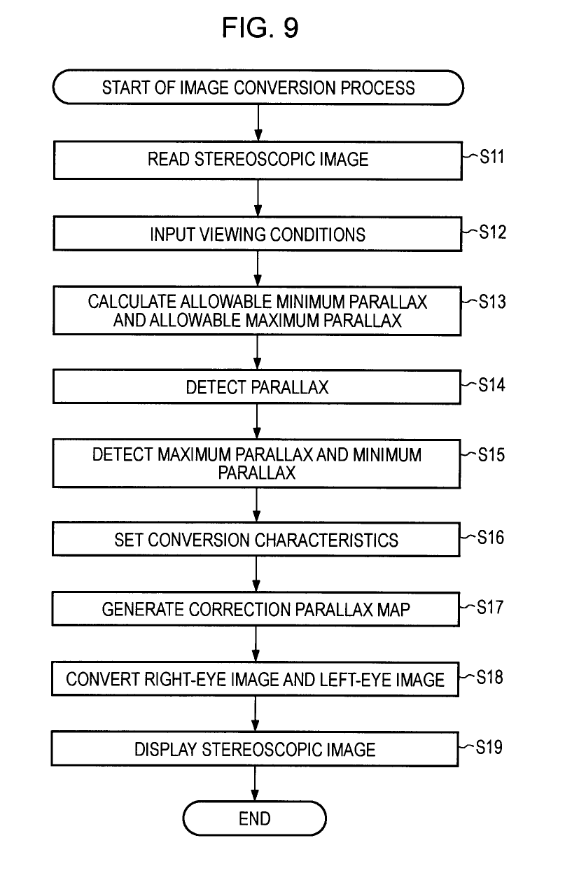

Next, the process of the stereoscopic image display system will be described. When the stereoscopic image display system receives an instruction to reproduce a stereoscopic image from a user, the stereoscopic image display system performs an image conversion process of converting the designated stereoscopic image into a stereoscopic image with an appropriate parallax and reproduces the stereoscopic image. The image conversion process of the stereoscopic image display system will be described with reference to the flowchart of FIG. 9.

In step S11, the parallax conversion apparatus 12 reads a stereoscopic image from the image recording apparatus 11. That is, the parallax detection unit 42 and the image synthesis unit 45 reads the right-eye image R and the left-eye image L from the image recording apparatus 11.

In step S12, the input unit 41 inputs the viewing conditions received from the remote commander 51 to the allowable parallax calculation unit 61.

That is, the users operates the remote commander 51 to input the pupillary distance e, the display width W, and the view distance D as the viewing conditions. For example, the pupillary distance e may be input directly by the user or may be input when the user selects a category of “adults” or “children.” When the pupillary distance e is input by selecting the category of “children” or the like, the both-eye distance e is considered as the value of the average pupillary distance of the selected category.

When the viewing conditions are input in this way, the remote commander 51 transmits the input viewing conditions to the input unit 41. Then, the input unit 41 receives the viewing conditions from the remote commander 51 and inputs the viewing conditions to the allowable parallax calculation unit 61.

The display width W serving as the viewing condition may be acquired from the image display apparatus 14 or the like by the input unit 41. The input unit 41 may acquire a display size from the image display apparatus 14 or the like and may calculate the view distance D from the acquired display size in that the view distance D is a standard view distance for the display size.

Further, the viewing conditions may be acquired from the input unit 41 in advance before the start of the image conversion process and may be supplied to the allowable parallax calculation unit 61, as necessary. The input unit 41 may be configured by an operation unit such as a button. In this case, when the user operates the input unit 41 to input the viewing conditions, the input unit 41 acquires a signal generated in accordance with the user operation as the viewing conditions.

In step S13, the allowable parallax calculation unit 61 calculates the allowable minimum parallax dₘᵢₙ′ and the allowable maximum parallax dₘₐₓ′ based on the viewing conditions supplied from the input unit 41 and supplies the allowable minimum parallax dₘᵢₙ′ and the allowable maximum parallax dₘₐₓ′ to the setting unit 63.

For example, the allowable parallax calculation unit 61 calculates the allowable minimum parallax dₘᵢₙ′ and the allowable maximum parallax dₘₐₓ′ by calculating Expression (9) and Expression (10) described above based on the pupillary distance e, the display width W, and the view distance D as the viewing conditions.

In step S14, the parallax detection unit 42 detects the parallax of each pixel between the right-eye image R and the left-eye image L based on the right-eye image R and the left-eye image L supplied from the image recording apparatus 11, and then supplies the parallax map indicating the parallax of each pixel to the maximum/minimum parallax detection unit 62 and the corrected parallax calculation unit 44.

For example, the parallax detection unit 42 detects the parallax of the left-eye image L relative to the right-eye image R for each pixel by DP (Dynamic Programming) matching by using the left-eye image L as a reference, and generates the parallax map indicating the detection result.

Further, the parallaxes for both the left-eye image L and the right-eye image R may be obtained to process a concealed portion. The method of estimating the parallax is a technique according to the related art. For example, there is a technique for estimating the parallax between right and left images and generating the parallax map by performing matching on a foreground image excluding a background image from the right and left images (for example, see Japanese Unexamined Patent Application Publication No. 2006-114023).

In step S15, the maximum/minimum parallax detection unit 62 detects the maximum value and the minimum value among the parallaxes of the respective pixels shown in the parallax map based on the parallax map supplied from the parallax detection unit 42, and then supplies the maximum value and the minimum value of the parallax to the setting unit 63.

Hereinafter, the maximum value and the minimum value of the parallax detected by the maximum/minimum parallax detection unit 62 are appropriately also referred to as the maximum parallax d(i)ₘₐₓ and the minimum parallax d(i)ₘᵢₙ.

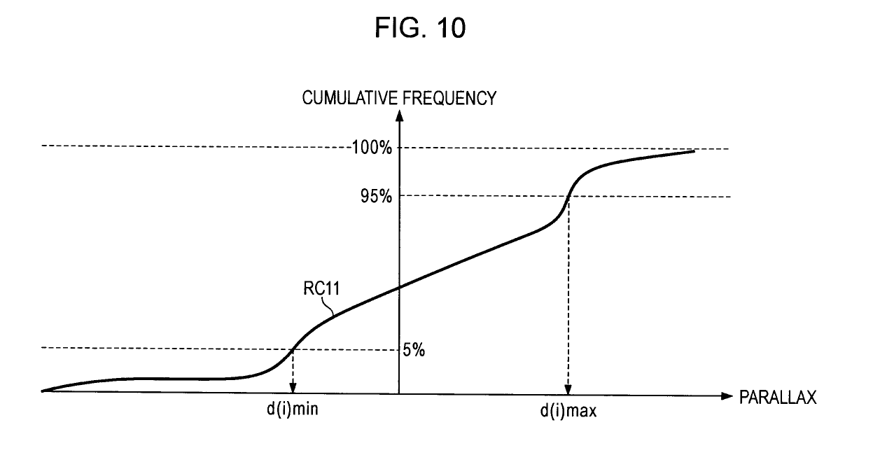

When the maximum value and the minimum value are detected, a cumulative frequency distribution may be used in order to stabilize the detection result. In this case, the maximum/minimum parallax detection unit 62 generates the cumulative frequency distribution shown in FIG. 10 for example. In the drawing, the vertical axis represents a cumulative frequency and the horizontal axis represents a parallax.

In the example of FIG. 10, a curve RC11 represents the number (cumulative frequency) of pixels having a value up to each parallax as a pixel value among pixels on the parallax map in the values of the parallaxes which the pixels on the parallax map have as the pixel values. When the maximum/minimum parallax detection unit 62 generates this cumulative frequency distribution, for example, the maximum/minimum parallax detection unit 62 sets the values of parallaxes representing a cumulative frequency of 5% and a cumulative frequency of 95% with respect to the entire cumulative frequency as the minimum parallax and the maximum parallax, respectively.

In this way, it is possible to stabilize the detection result by setting the parallax corresponding to the cumulative frequency corresponding to a preset ratio with respect to a total of the number of parallaxes as the minimum parallax or the maximum parallax and excluding the extremely large or small parallaxes.

In step S16, the setting unit 63 sets the conversion characteristics based on the minimum parallax and the maximum parallax from the maximum/minimum parallax detection unit 62 and the parallax dₘᵢₙ′ and the parallax dₘₐₓ′ from the allowable parallax calculation unit 61, and then supplies the conversion characteristics to the corrected parallax calculation unit 44.

For example, the setting unit 63 determines the conversion characteristics so that the parallax of each pixel of the stereoscopic image is converted into a parallax falling within a range (hereinafter, referred to as an allowable parallax range) from the allowable minimum parallax dₘᵢₙ′ to the allowable maximum parallax dₘₐₓ′ based on the minimum parallax, the maximum parallax, the allowable minimum dₘᵢₙ′, and the allowable maximum parallax dₘₐₓ′.

Specifically, when the minimum parallax and the maximum parallax fall within the allowable parallax range, the setting unit 63 sets an equivalent conversion function, in which the parallax map becomes the corrected parallax map without change, as the conversion characteristics. In this case, the reason for setting the equivalent conversion function as the conversion characteristic is that it is necessary to control the parallax for the stereoscopic image since the parallax of each pixel of the stereoscopic image is the parallax with a magnitude suitable for the allowable parallax range.

On the other hand, when at least one of the minimum parallax and the maximum parallax does not fall within the allowable parallax range, the setting unit 63 determines the conversion characteristics for correcting (converting) the parallax of each pixel of the stereoscopic image. That is, when the pixel value (value of the parallax) of a pixel on the parallax map is set to an input parallax d(i) and the pixel value (value of the parallax) of a pixel, which is located at the same position as that of the pixel on the parallax map, on the corrected parallax map is set to a corrected parallax d(o), a conversion function of converting the input parallax d(i) into the corrected parallax d(o) is determined.

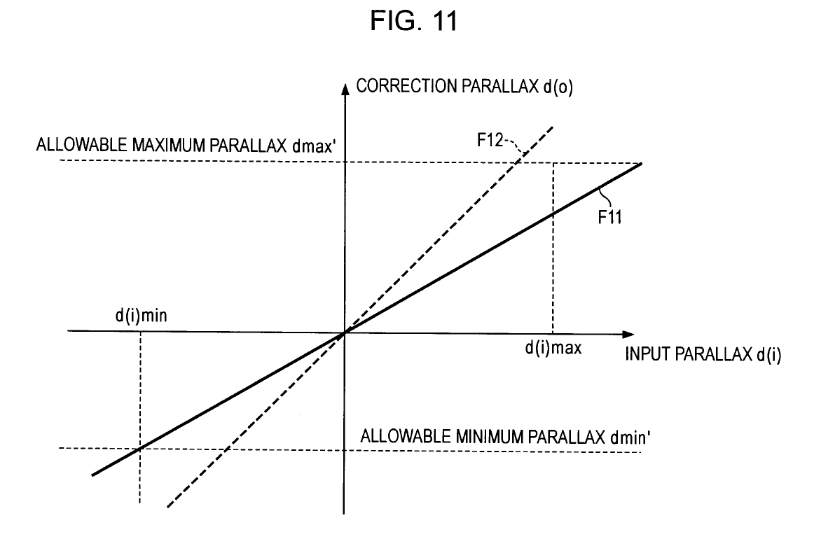

In this way, for example, a conversion function shown in FIG. 11 is determined. In FIG. 11, the horizontal axis represents the input parallax d(i) and the vertical axis represents the corrected parallax d(o). In FIG. 11, straight lines F11 and F12 represent graphs of the conversion function.

In the example of FIG. 11, the straight line F12 represents the graph of the conversion function when the input parallax d(i) is equal to the corrected parallax d(o), that is, the graph of equivalent conversion. As described above, when the minimum parallax and the maximum parallax fall within the allowable parallax range, a relation of d(o)=d(i) is satisfied in the conversion function.

In the example of FIG. 11, however, the minimum parallax is smaller than the allowable minimum parallax dₘᵢₙ′ and the maximum parallax is larger than the allowable maximum parallax dₘₐₓ′. Therefore, when the input parallax d(i) is equivalently converted and set to the corrected parallax d(o) without change, the minimum value and the maximum value of the corrected parallax may become a parallax falling out of the allowable parallax range.

Accordingly, the setting unit 63 sets a linear function indicated by the straight line F11 as the conversion function so that the corrected parallax of each pixel becomes the parallax falling within the allowable parallax range.

Here, the conversion function is determined such that the input parallax d(i)=0 is converted into the corrected parallax d(o)=0, the minimum parallax d(i)ₘᵢₙ is converted into a parallax equal to or greater than the allowable minimum parallax dₘᵢₙ′, and the maximum parallax d(i)ₘₐₓ is converted to a parallax equal to or less than the allowable maximum parallax dₘₐₓ′.

In the conversion function indicated by the straight line F11, the input parallax d(i)=0 is converted into 0, the minimum parallax d(i)ₘᵢₙ is converted into the allowable minimum parallax dₘᵢₙ′, and the maximum parallax d(i)ₘₐₓ is converted into a parallax equal to or less than the allowable maximum parallax dₘₐₓ′.

When the setting unit 63 determines the conversion function (conversion characteristics) in this way, the setting unit 63 supplies the determined conversion function as the conversion characteristics to the corrected parallax calculation unit 44.

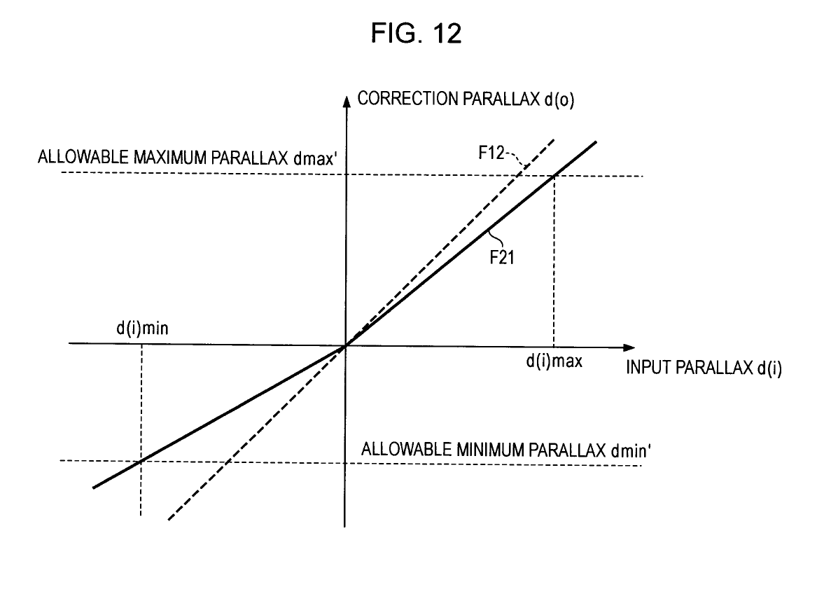

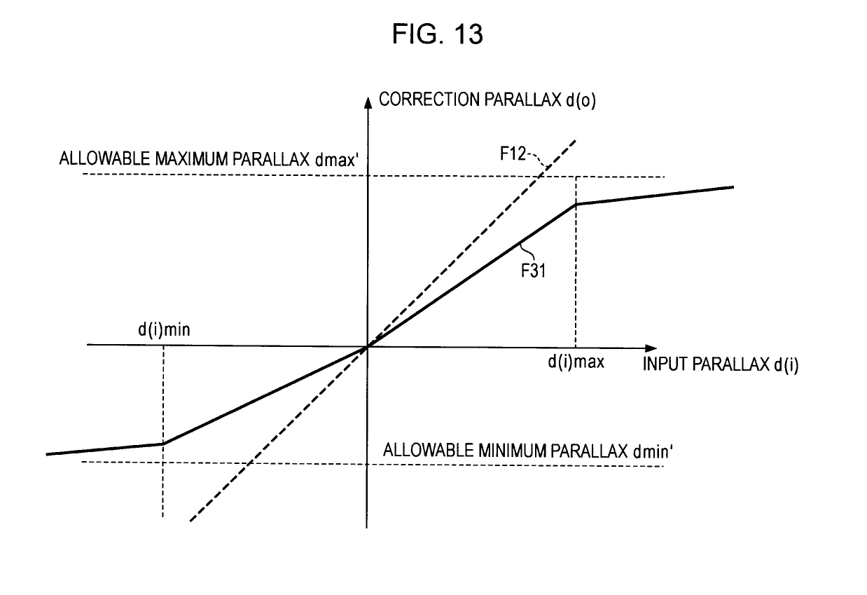

Further, the conversion characteristics are not limited to the example shown in FIG. 11, but may be set as any function such as a function expressing the parallax as a monotonically increasing broken-line for the parallax. For example, conversion characteristics shown in FIG. 12 or 13 may be used. In FIGS. 12 and 13, the horizontal axis represents the input parallax d(i) and the vertical axis represents the corrected parallax d(o). In the drawings, the same reference numerals are given to the portions corresponding to the portions of FIG. 11 and the description thereof will not be repeated.

In FIG. 12, a broken line F21 indicates a graph of the conversion function. In the conversion function indicated by the broken line F21, the input parallax d(i)=0 is converted into 0, the minimum parallax d(i)ₘᵢₙ is converted into the allowable minimum parallax dₘᵢₙ′, and the maximum parallax d(i)ₘₐₓ is converted into the allowable maximum parallax dₘₐₓ′. In the conversion function indicated by the broken line F21, the slope of a section from the minimum parallax to 0 is different from the slope of a section from 0 to the maximum parallax d(i)ₘₐₓ and the linear function is realized in both the sections.

In the example of FIG. 13, a broken line F31 indicates a graph of the conversion function. In the conversion function indicated by the broken line F31, the input parallax d(i)=0 is converted into 0, the minimum parallax d(i)ₘᵢₙ is converted into a parallax equal to or greater than the allowable minimum parallax dₘᵢₙ′, and the maximum parallax d(i)ₘₐₓ is converted into a parallax equal to or less than the allowable maximum parallax dₘₐₓ′.

In the conversion function indicated by the broken line F31, the slope of a section from the minimum parallax d(i)ₘᵢₙ to 0 is different from the slope of a section from 0 to the maximum parallax d(i)ₘₐₓ and the linear function is realized in both the sections.

Further, the slope of the conversion function in a section equal to or less than the minimum parallax d(i)ₘᵢₙ is different from the slope of the conversion function in a section from the minimum parallax d(i)ₘᵢₙ to 0. Therefore, the slope of the conversion function in a section from 0 to the maximum parallax d(i)ₘₐₓ is different from the slope of the conversion function in a section equal to or greater than the maximum parallax d(i)ₘₐₓ.

In particular, the conversion function indicated by the broken line F31 is effective when the minimum parallax d(i)ₘᵢₙ or the maximum parallax d(i)ₘₐₓ is the minimum value or the maximum value of the parallax shown in the parallax map, respectively, for example, the maximum parallax and the minimum parallax are determined by the cumulative frequency distribution. In this case, by decreasing the slope of the conversion characteristics which are equal to or less than the minimum parallax d(i)ₘᵢₙ or equal to or greater than the maximum parallax d(i)ₘₐₓ, the parallax with an exceptionally large absolute value included in the stereoscopic image can be converted into a parallax suitable for viewing the stereoscopic image more easily.

Referring back to the flowchart of FIG. 9, the process proceeds from step S16 to step S17 when the conversion characteristics are set.

In step S17, the corrected parallax calculation unit 44 generates the corrected parallax map based on the conversion characteristics supplied from the setting unit 63 and the parallax map from the parallax detection unit 42, and then supplies the corrected parallax map to the image synthesis unit 45.

That is, the corrected parallax calculation unit 44 calculates the corrected parallax d(o) by substituting the parallax (input parallax d(i)) of the pixel of the parallax map into the conversion function serving as the characteristic conversions and sets the calculated corrected parallax as the pixel value of the pixel, which is located at the same position as that of the pixel, on the corrected parallax map.

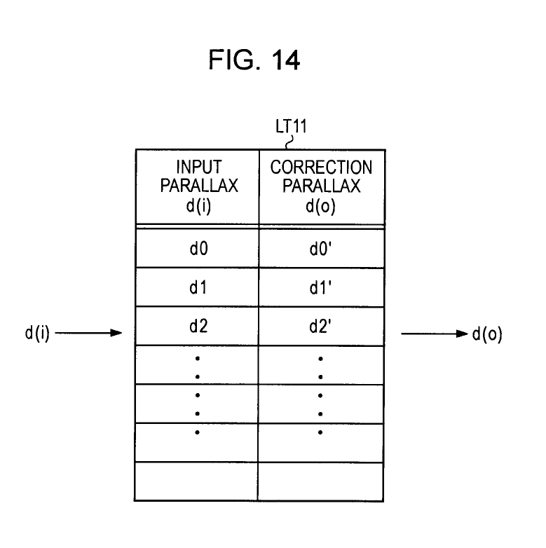

The calculation of the corrected parallax d(o) performed using the conversion function may be realized through a lookup table LT11 shown in FIG. 14, for example.

The lookup table LT11 is used to convert the input parallax d(i) into the corrected parallax d(o) by predetermined conversion characteristics (conversion function). In the lookup table LT11, the respective values of the input parallax d(i) the values of the corrected parallax d(o) obtained by substitution of the values to the conversion function are matched to each other and recorded in a correspondence with each other.

In the lookup table LT11, for example, a value “d0” of the input parallax d(i) and a value “d0′” of the corrected parallax d(o) obtained by substitution of the value “d0” into the conversion function are recorded in correspondence with each other. When this kind of lookup table LT11 is recorded for various conversion characteristics, the corrected parallax calculation unit 44 can easily obtain the corrected parallax d(o) for the input parallax d(i) without calculation of the conversion function.

Referring back to the flowchart of FIG. 9, the process proceeds from step S17 to step S18 when the corrected parallax map is generated by the corrected parallax calculation unit 44 and is supplied to the image synthesis unit 45.

In step S18, the image synthesis unit 45 converts the right-eye image R and the left-eye image L from the image recording apparatus 11 by the use of the corrected parallax map from the corrected parallax calculation unit 44 into the right-eye image R′ and the left-eye image L′ having the appropriate parallax, and then supplies the right-eye image R′ and the left-eye image L′ to the display control apparatus 13.

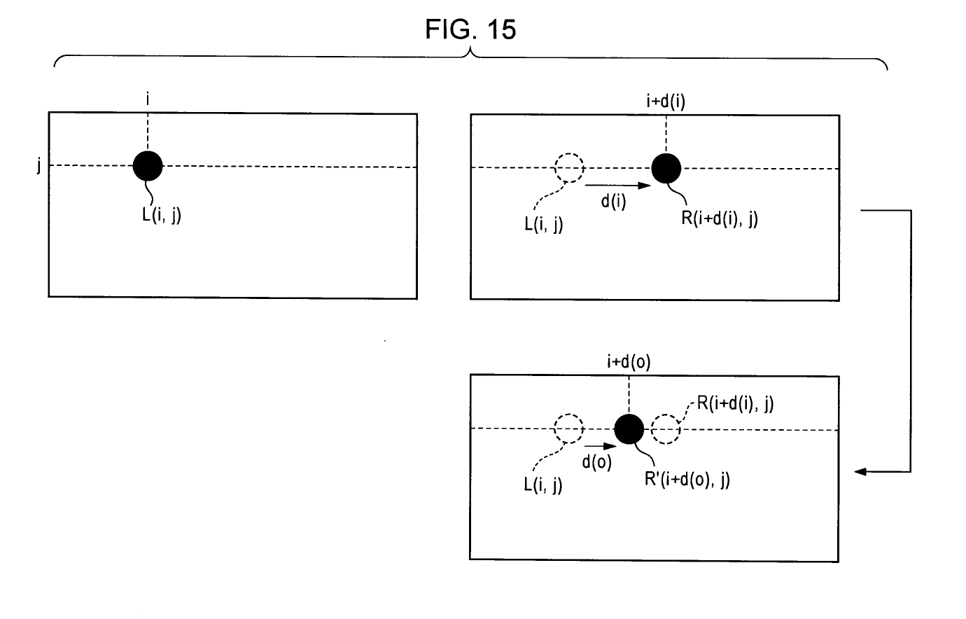

For example, as shown in FIG. 15, in an ij coordinate system in which the horizontal and vertical directions of the drawing are assumed to be i and j directions, respectively, it is assumed that a pixel located at coordinates (i, j) on the left-eye image L is L(i, j) and a pixel located at coordinates (i, j) on the right-eye image R is R(i, j). Further, it is assumed that a pixel located at coordinates (i, j) on the left-eye image L′ is L′(i, j) and a pixel located at coordinates (i, j) on the right-eye image R′ is R′(i, j).

Furthermore, it is assumed that the pixel values of the pixel L(i, j), the pixel R(i, j), the pixel L′(i, j), and the pixel R′(i, j) are L(i, j), R(i, j), L′(i, j), and R′(i, j), respectively. It is assumed that the input parallax of the pixel L(i, j) shown in the parallax map is d(i) and the corrected parallax of the input parallax d(i) subjected to correction is d(o).

In this case, the image synthesis unit 45 sets the pixel value of the pixel L(i, j) on the left-eye image L to the pixel of the pixel L′(i, j) on the left-eye image L′ without change, as shown in Expression (11) below.

L′(i,j)=L(i,j) (11)

The image synthesis unit 45 calculates the pixel on the right-eye image R′ corresponding to the pixel L′(i, j) as the pixel R′(i+d(o), j) by Expression (12) below to calculate the pixel value of the pixel R′(i+d(o), j).

$${R}^{′} ( i + d ( o ) , j ) = \frac{\vert d ( i ) - d ( o ) \vert L ( i , j ) + d ( o ) R ( i + d ( i ) , j )}{\vert d ( i ) - d ( o ) \vert + d ( o )} \qquad ( 12 )$$

That is, since the input parallax between the right-eye image and the left-eye image before correction is d(i), as shown in the upper part of the drawing, the pixel on the right-eye image R corresponding to the pixel L(i, j), that is, the pixel by which the same subject as that of the pixel L(i, j) is displayed is a pixel R (i+d(i), j).

Since the input parallax d(i) is corrected to easily become the corrected parallax d(o), as shown in the lower part of the drawing, the pixel on the right-eye image R′ corresponding the pixel L′(i, j) on the left-eye image L′ is a pixel R′(i+d(o), j) distant from the position of the pixel L(i, j) by the corrected parallax d(o). The pixel R′(i+d(o), j) is located between the pixel L(i, j) and the pixel R(i+d(i), j).

Thus, the image synthesis unit 45 calculates Expression (12) described above and calculates the separation between the pixel values of the pixel L(i, j) and the pixel R(i+d(o), j) to calculate the pixel value of the pixel R′(i+d(o), j).

In this way, the image synthesis unit 45 sets one corrected image obtained by correcting one image of the stereoscopic image without change and calculates the separation between the pixel of the one image and the pixel of the other image corresponding to the pixel so as to calculate the pixel of the other image subjected to the parallax correction and obtain the corrected stereoscopic image.

Referring back to the flowchart of FIG. 9, the process proceeds from step S18 to step S19 when the stereoscopic image formed by the right-eye image R′ and the left-eye image L′ can be obtained.

In step S19, the display control apparatus 13 supplies the image display apparatus 14 with the stereoscopic image formed by the right-eye image R′ and the left-eye image L′ supplied from the image synthesis unit 45 so as to display the stereoscopic image, and then the image conversion process ends.

For example, the image display apparatus 14 displays the stereoscopic image by displaying the right-eye image R′ and the left-eye image L′ in accordance with a display method such as a lenticular lens method under the control of the display control apparatus 13.

In this way, the stereoscopic image display system acquires the pupillary distance e, the display width W, and the view distance D as the viewing conditions, converts the stereoscopic image to be displayed into the stereoscopic image with a more appropriate parallax, and displays the converted stereoscopic image. Thus, it is possible to simply obtain the more appropriate sense of depth irrespective of the viewing conditions of the stereoscopic image by generating the stereoscopic image with the parallax suitable for the viewing conditions in accordance with the viewing conditions.

For example, the stereoscopic image suitable for adults may give a large burden on children with a narrow both-eye distance. However, the stereoscopic image display system can present the stereoscopic image of the parallax suitable for the pupillary distance e of each user by acquiring the both-eye distance e as the viewing condition and controlling the parallax of the stereoscopic image. Likewise, the stereoscopic image display system can present the stereoscopic image of the normally suitable parallax in accordance with the size of the display screen, the view distance, or the like of the image display apparatus 14 by acquiring the display width W or the view distance D as the viewing conditions.

### Second Embodiment

### Example of Configuration of Stereoscopic Image Display System

The case has been exemplified in which the user inputs the viewing conditions, but the parallax conversion apparatus 12 may calculate the viewing conditions.

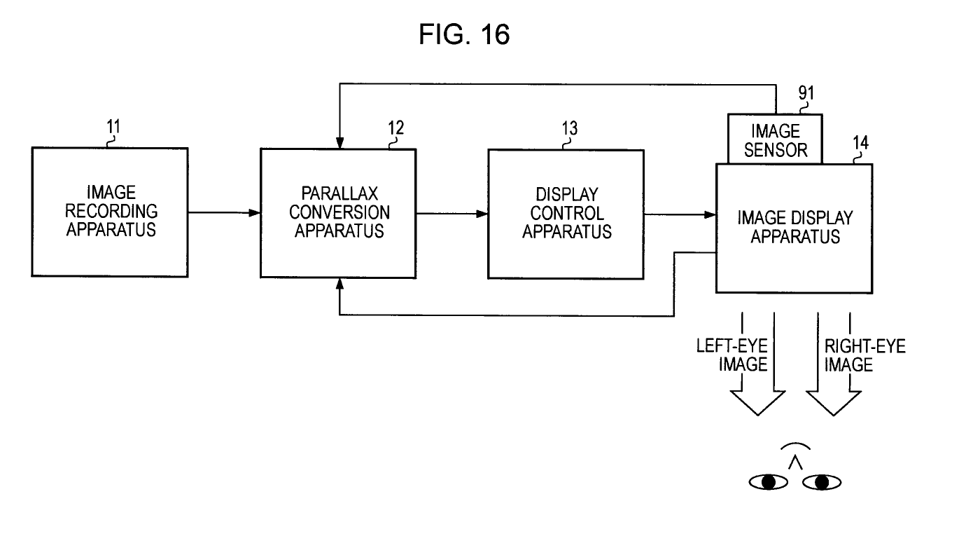

In this case, the stereoscopic image display system has a configuration shown in FIG. 16, for example. The stereoscopic image display system in FIG. 16 further includes an image sensor 91 in addition to the units of the stereoscopic image display system shown in FIG. 7.

The parallax conversion apparatus 12 acquires display size information regarding the size (display size) of the display screen of the image display apparatus 14 from the image display apparatus 14 and calculates the display width W and the view distance D as the viewing conditions based on the display size information.

The image sensor 91, which is fixed to the image display apparatus 14, captures an image of a user watching a stereoscopic image displayed on the image display apparatus 14 and supplies the captured image to the parallax conversion apparatus 12. The parallax conversion apparatus 12 calculates the pupillary distance e based on the image from the image sensor 91 and the view distance D.

### Example of Configuration of Parallax Conversion Apparatus

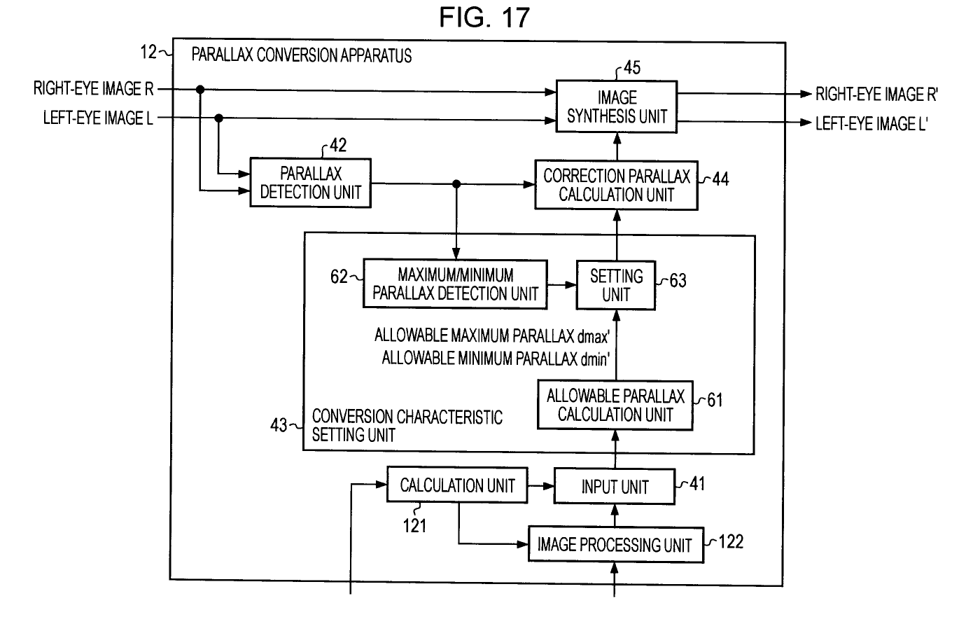

The parallax conversion apparatus 12 of the stereoscopic image display system shown in FIG. 16 has a configuration shown in FIG. 17. In FIG. 17, the same reference numerals are given to units corresponding to the units of FIG. 8 and the description thereof will not be repeated.

The parallax conversion apparatus 12 in FIG. 17 further include a calculation unit 121 and an image processing unit 122 in addition to the units of the parallax conversion apparatus 12 in FIG. 8.

The calculation unit 121 acquires the display size information from the image display apparatus 14 and calculates the display width W and the view distance D based on the display size information. Further, the calculation unit 121 supplies the calculated display width W and the calculated view distance D to the input unit 41 and supplies the view distance D to the image processing unit 122.

The image processing unit 122 calculates the pupillary distance e based on the image supplied from the image sensor 91 and the view distance D supplied from the calculation unit 121 and supplies the pupillary distance e to the input unit 41.

### Image Conversion Process

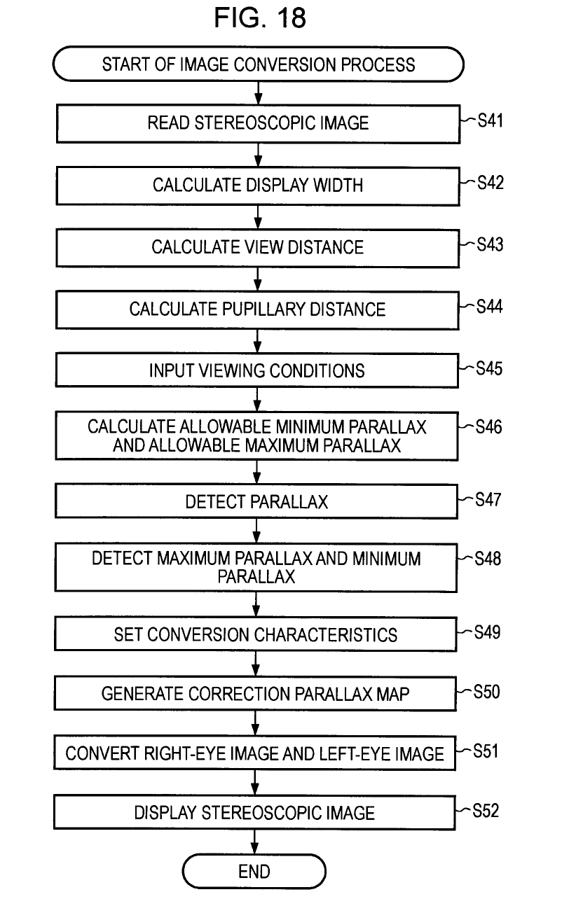

Next, an image conversion process performed by the stereoscopic image display system in FIG. 16 will be described with reference to the flowchart of FIG. 18. Since the process of step S41 is the same as the process of step S11 in FIG. 9, the description thereof will not be repeated.

In step S42, the calculation unit 121 acquires the display size information from the image display apparatus 14 and calculates the display width W from the acquired display size information.

In step S43, the calculation unit 121 calculates the view distance D from the acquired display size information. For example, the calculation unit 121 sets, as the view distance D, a triple value of the height of the display screen in the acquired display size acquired as the standard view distance of the view distance D for the display size. The calculation unit 121 supplies the calculated display width W and the view distance D to the input unit 41 and supplies the view distance D to the image processing unit 122.

In step S44, the image processing unit 122 acquires the image of the user from the image sensor 91, calculates the pupillary distance e based on the acquired image and the view distance D from the calculation unit 121, and supplies the pupillary distance to the input unit 41.

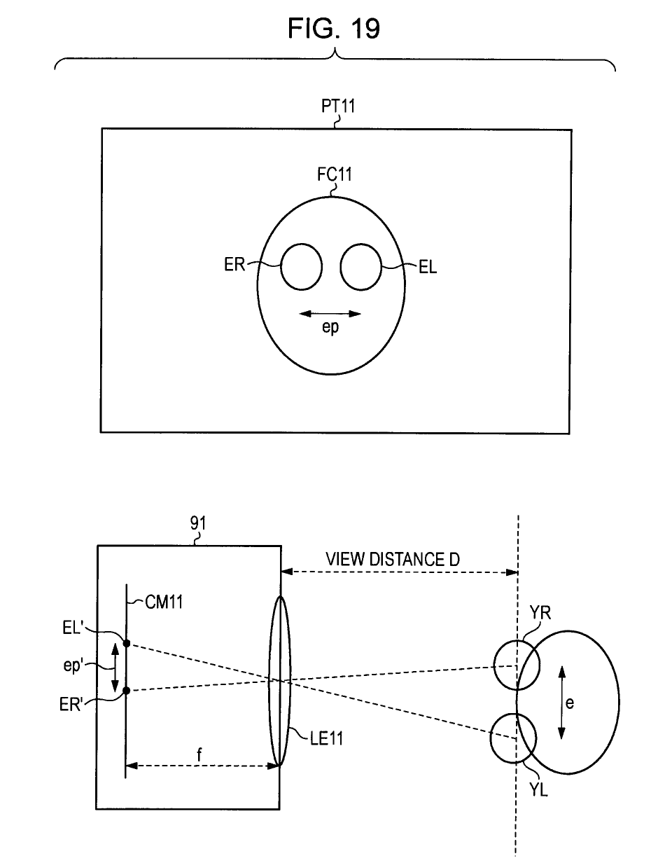

For example, the image sensor 91 captures an image PT11 of a user in the front of the image display apparatus 14, as shown in the upper part of FIG. 19 and supplies the captured image PT11 to the image processing unit 122. The image processing unit 122 detects a facial region FC11 of the user from the image PT11 through face detection and detects a right-eye region ER and a left-eye region EL of the user from the region FC11.

The image processing unit 122 calculates a distance ep using the number of pixels from the region ER to the region EL as a unit and calculates the both-eye distance e from the distance ep.

That is, as shown in the lower part of FIG. 19, the image sensor 91 includes a sensor surface CM11 of a sensor capturing the image PT11 and a lens LE11 condensing light from the user. It is assumed that the light from the right eye YR of the user reaches a position ER′ of the sensor surface CM11 via the lens LE11 and the light from the left eye YL of the user reaches a position EL′ of the sensor surface CM11 via the lens LE11.

Further, it is assumed that the distance between the sensor surface CM11 to the lens LE11 is a focal distance f and the distance between the lens LE11 to the user is the view distance D. In this case, the image processing unit 122 calculates a distance ep′ between the position ER′ to the position EL′ on the sensor surface CM11 from the distance ep between both the eyes of the user on the image PT11 and calculates the pupillary distance e by calculating Expression (13) from the distance ep′, the focal distance f, and the view distance D.

pupillary distance e=D×ep′/f (13)

Referring back to the flowchart of FIG. 18, the process proceeds to step S45 when the pupillary distance e is calculated. In step S45, the input unit 41 inputs, as the viewing conditions, the display width W and the view distance D from the calculation unit 121 and the pupillary distance e from the image processing unit 122 to the allowable parallax calculation unit 61.

When the viewing condition is input, the processes from step S46 to step S52 are subsequently performed and the image conversion process ends. Since the processes are the same as those of step S13 to step S19 of FIG. 9, the description thereof will not be repeated.

In this way, the stereoscopic image display system calculates the viewing conditions and controls the parallax of the stereoscopic image under the viewing conditions. Accordingly, since the user may not input the viewing conditions, the user can watch the stereoscopic image of the parallax which is simpler and more appropriate.

### Third Embodiment

### Example of Configuration of Stereoscopic Image Display System

Hitherto, the case has been described in which the view distance D is calculated from the display size information. However, the view distance may be calculated from the image captured by the image sensor.

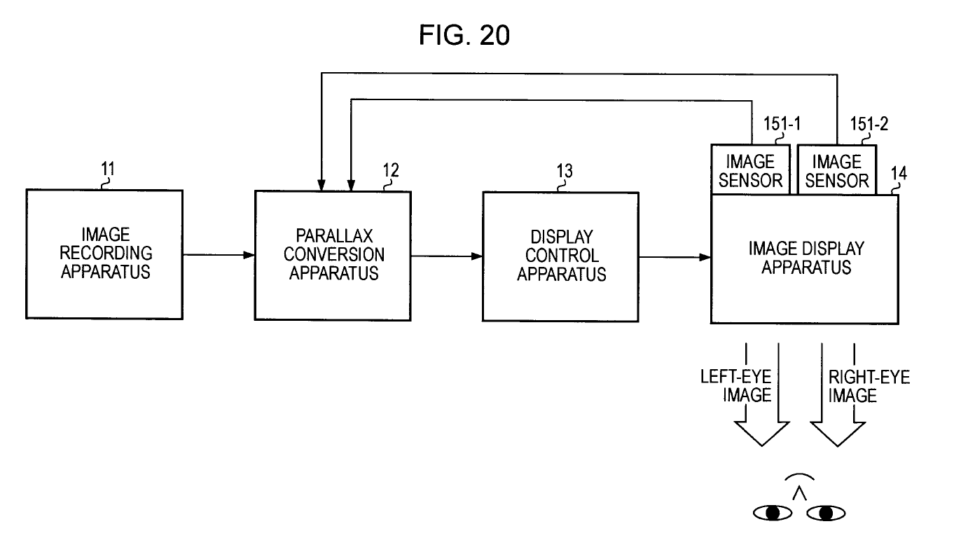

In this case, the stereoscopic image display system has a configuration shown in FIG. 20, for example, the stereoscopic image display system in FIG. 20 further includes image sensors 151-1 and 151-2 in addition to the units of the stereoscopic image display system shown in FIG. 7.

The image sensors 151-1 and 151-2, which are fixed to the image display apparatus 14, capture the images of the user watching the stereoscopic image displayed by the image display apparatus 14 and supply the captured image to the parallax conversion apparatus 12. The parallax conversion apparatus 12 calculates the view distance D based on the images supplied from the image sensors 151-1 and 151-2.

Hereinafter, when it is not necessary to distinguish the image sensors 151-1 and 151-2, the image sensors 151-1 and 151-2 are simply referred to as the image sensors 151.

### Example of Configuration of Parallax Conversion Apparatus

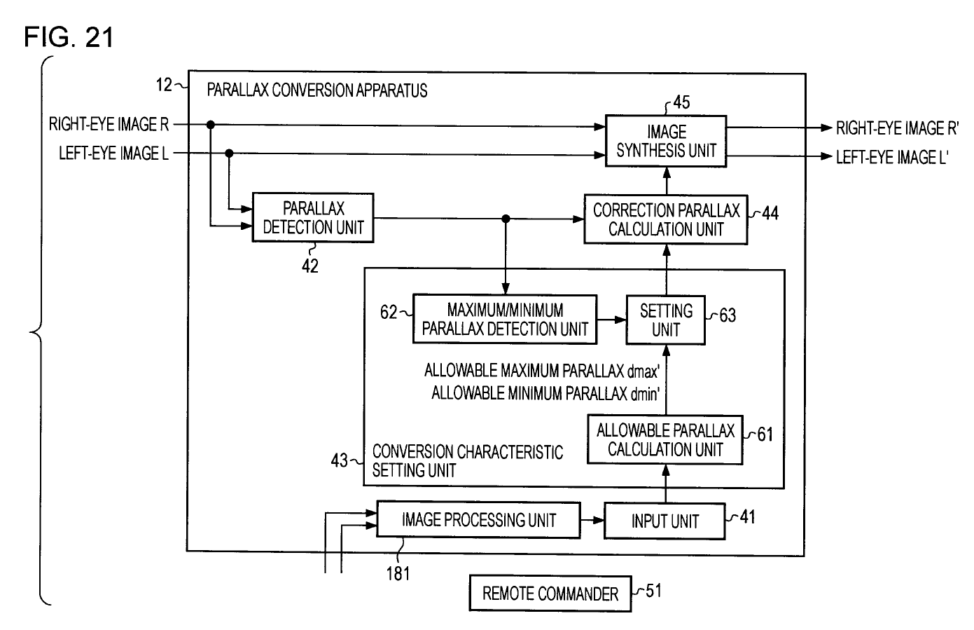

The parallax conversion apparatus 12 of the stereoscopic image display system shown in FIG. 20 has a configuration shown in FIG. 21. In FIG. 21, the same reference numerals are given to units corresponding to the units of FIG. 8 and the description thereof will not be repeated.

The parallax conversion apparatus 12 in FIG. 21 further includes an image processing unit 181 in addition to the units of the stereoscopic conversion apparatus 12 in FIG. 8. The image processing unit 181 calculates the view distance D as the viewing condition based on the images supplied from the images sensors 151 and supplies the view distance D to the input unit 41.

### Image Conversion Process

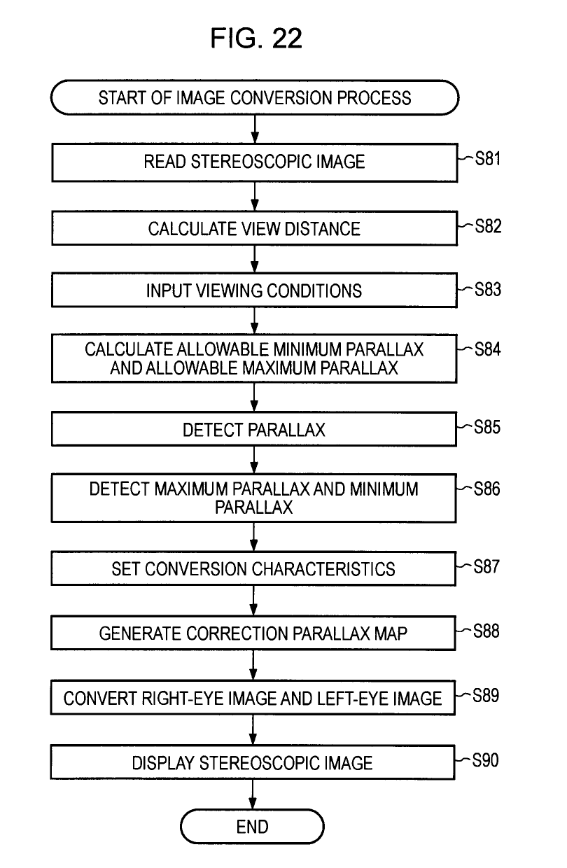

Next, an image conversion process performed by the stereoscopic image display system in FIG. 20 will be described with reference to the flowchart of FIG. 22. Since the process of step S81 is the same as the process of step S11 in FIG. 9, the description thereof will not be repeated.

In step S82, the image processing unit 181 calculates the view distance D as the viewing condition based on the images supplied from the image sensors 151 and supplies the view distance D to the input unit 41.

For example, the image sensors 151-1 and 151-2 capture the images of the user in the front of the image display apparatus 14 and supply the captured images to the image processing unit 181. Here, the images of the user captured by the image sensors 151-1 and 151-2 are images having a parallax one another.

The image processing unit 181 calculates the parallax between the images based on the images supplied from the image sensors 151-1 and 151-2 and calculates the view distance D between the image display apparatus 14 to the user using the principle of triangulation. The image processing unit 181 supplies the view distance D calculated in this way to the input unit 41.

In step S83, the input unit 41 receives the display width W and the pupillary distance e from the remote commander 51 and inputs the display width W and the pupillary distance e together with the view distance D from the image processing unit 181 as the viewing conditions to the allowable parallax calculation unit 61. In this case, as in step S12 of FIG. 9, the user operates the remote commander 51 to input the display width W and the pupillary distance e.

When the viewing conditions are input, the processes from step S84 to step S90 are performed and the image conversion process ends. Since the processes are the same as those from step S13 to step S19 of FIG. 9, the description thereof will not be repeated.

In this way, the stereoscopic image display system calculates the view distance D as the viewing condition from the images of the user and controls the parallax of the stereoscopic image under the viewing conditions. Accordingly, since the user can watch the stereoscopic image of the appropriate parallax more simply through the fewer operations.

Hitherto, the example has been described in which the view distance D is calculated from the images captured by the two image sensors 151 by the principle of triangulation. However, any method may be used to calculate the view distance D.

For example, a projector projecting a specific pattern may be provided instead of the image sensors 151 to calculate the view distance D based on the pattern projected by the projector. Further, a distance sensor measuring the distance between the image display apparatus 14 to the user may be provided. The distance sensor may calculate the view distance D.

The above-described series of processes may be executed by hardware or software. When the series of processes are executed by software, a program for the software is installed in a computer embedded in dedicated hardware or is installed from a program recording medium to, for example, a general personal computer capable of executing various kinds of functions by installing various kinds of programs.

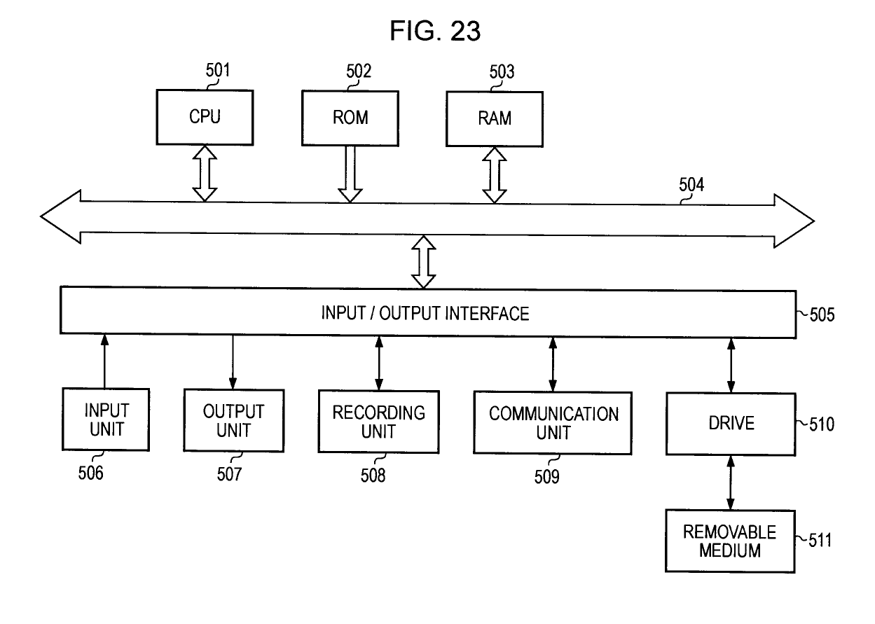

FIG. 23 is a block diagram illustrating an example of the hardware configuration of a computer executing the above-described series of processes in accordance with a program.

In the computer, a CPU (Central Processing Unit) 501, a ROM (Read Only Memory) 502, and a RAM (Random Access Memory) 503 are connected to each other via a bus 504.

An input/output interface 505 is also connected to the bus 504. An input unit 506 configured by a keyboard, a mouse, a microphone, or the like, an output unit 507 configured by a display, a speaker, or the like, a recording unit 508 configured by a hard disk, a non-volatile memory, or the like, a communication unit 509 configured by a network interface or the like, and a drive 510 driving a removable medium 511 such as a magnetic disk, an optical disc, a magneto-optical disc, or a semiconductor memory are connected to the input/output interface 505.

In the computer having the above-described configuration, the CPU 501 executes the above-described series of processes by loading and executing the program stored in the recording unit 508 on the RAM 503 via the input/output interface 505 and the bus 504.

The program executed by the computer (CPU 501) is stored in the removable medium 511 which is a package medium configured by, for example, a magnetic disk (including a flexible disk), an optical disc (a CD-ROM (Compact Disc-Read Only Memory), a DVD (Digital Versatile Disc), or the like), a magneto-optical disc, or a semiconductor memory or is supplied via a wired or wireless transmission medium such as a local area network, the Internet, or a digital satellite broadcast.

The program can be installed to the recording unit 508 via the input/output interface 505 by loading the removable medium 511 to the drive 510. Further, the program may be received by the communication unit 509 via the wired or wireless transmission medium and may be installed in the recording unit 508. Furthermore, the program may be installed in advance in the ROM 502 or the recording unit 508.

The program executed by the computer may be a program processed chronologically in the order described in the specification or may be a program processed in parallel or at a necessary timing at which the program is called.

The forms of the present technique are not limited to the above-described embodiments, but may be modified in various forms without departing from the gist of the present technique.

Further, the present technique may be configured as follows.

[1] An image processing apparatus includes: an input unit inputting a viewing condition of a stereoscopic image to be displayed; a conversion characteristic setting unit determining a conversion characteristic used to correct a parallax of the stereoscopic image based on the viewing condition; and a corrected parallax calculation unit correcting the parallax of the stereoscopic image based on the conversion characteristic.

[2] In the image processing apparatus described in [1], the viewing condition includes at least one of a pupillary distance of a user watching the stereoscopic image, a view distance of the stereoscopic image, and a width of a display screen on which the stereoscopic image is displayed.

[3] In the image processing apparatus described in [1] or [2], the image processing apparatus further includes an allowable parallax calculation unit calculating a parallax range in which the corrected parallax of the stereoscopic image falls based on the viewing condition. The conversion characteristic setting unit determines the conversion characteristic based on the parallax range and the parallax of the stereoscopic image.

[4] In the image processing apparatus described in [3], the conversion characteristic setting unit sets, as the conversion characteristic, a conversion function of converting the parallax of the stereoscopic image into the parallax falling within the parallax range.

[5] The image processing apparatus described in any one of [1] to [4] further includes an image conversion unit converting the stereoscopic image into a stereoscopic image with the parallax corrected by the corrected parallax calculation unit.

[6] The image processing apparatus described in [2] further includes a calculation unit acquiring information regarding a size of the display screen and calculating the width of the display screen and the view distance based on the information.

[7] The image processing apparatus described in [6] further includes an image processing unit calculating the pupillary distance based on an image of the user watching the stereoscopic image and the view distance.

[8] The image processing apparatus described in [2] further includes an image processing unit calculating the view distance based on a pair of images which have a parallax each other and are images of the user watching the stereoscopic image.

It should be understood by those skilled in the art that various modifications, combinations, sub-combinations and alterations may occur depending on design requirements and other factors insofar as they are within the scope of the appended claims or the equivalents thereof.

The overview and specific examples of the above-described embodiment and the other embodiments are examples. The present disclosure may also be applied and can be applied to various other embodiments. It should be understood by those skilled in the art that various modifications, combinations, sub-combinations and alterations may occur depending on design requirements and other factors insofar as they are within the scope of the appended claims or the equivalents thereof.

What is claimed is:

1. A computer-implemented method for adjusting display of a three-dimensional image, comprising:
receiving a viewing condition associated with an image being viewed by a user;
determining, by a processor, a conversion characteristic based on the viewing condition; and
adjusting, by the processor, a display condition of the image based on the conversion characteristic.

2. The method of claim 1, further comprising:
generating data representing an adjusted image based on the adjusted display condition; and
displaying the adjusted image using the generated data.

3. The method of claim 1, further comprising displaying, on a display device, the image, wherein the viewing condition is based on at least one of a distance between the display device and the user, a pupillary distance of a user watching the stereoscopic image, or a width of a display screen on which the stereoscopic image is displayed.

4. The method of claim 1, further comprising:
determining, based on the viewing condition, an allowable maximum parallax value and an allowable minimum parallax value corresponding to the image; and
determining an actual maximum parallax value and an actual minimum parallax value corresponding to the image, the conversion characteristic being determined based on:
a difference between the allowable maximum parallax value and the actual maximum parallax value; and
a difference between the allowable minimum parallax value and the actual minimum parallax value.

5. The method of claim 1, further comprising:
determining, based on the viewing condition, an allowable range of parallax values corresponding to the image; and
determining an actual range of parallax values corresponding to the image, the conversion characteristic being determined based on the allowable range of parallax values and the actual range of parallax values.

6. The method of claim 1, further comprising generating a parallax map based on the conversion characteristic, the display condition being adjusted based on the parallax map.

7. The method of claim 1, further comprising generating a parallax map based on the conversion characteristic, the parallax map identifying a pixel of the image which has an incorrect parallax.

8. The method of claim 7, wherein adjusting the display condition comprises
correcting a parallax of the identified pixel.

9. The method of claim 1, further comprising:
displaying the image based on a right-eye image and a left-eye image; and
generating a parallax map based on the conversion characteristic, the display condition of the image being adjusted by generating an adjusted right-eye image and adjusted left-eye image based on the parallax map.

10. The method of claim 1, further comprising determining an allowable range of parallax values based on the viewing condition, wherein the adjusting the display condition includes converting a parallax value of a pixel of the image to fall within the allowable range of parallax values.

11. The method of claim 1, further comprising displaying, on a display device, the image, wherein the viewing condition is based on a distance between a right-eye and a left-eye of the user.

12. The method of claim 1, wherein the viewing condition is based on at least one of a viewing distance, pupillary distance, or a depth distance associated with the image.

13. The method of claim 1, wherein the image is a stereoscopic image.

14. An apparatus for adjusting display of a three-dimensional image, comprising:
a display device for displaying an image for viewing by a user;
a memory storing the instructions; and
a processor executing the instructions to:
receive a viewing condition associated with the image;
determine a conversion characteristic based on the viewing condition; and
adjust a display condition of the image based on the conversion characteristic.

15. The apparatus of claim 14, wherein the viewing condition is based on at least one of a viewing distance, pupillary distance, or a depth distance associated with the image.

16. The apparatus of claim 14, wherein the processor executes the instructions to:
determine, based on the viewing condition, an allowable range of parallax values corresponding to the image; and
determine an actual range of parallax values corresponding to the image, the conversion characteristic being determined based on the allowable range of parallax values and the actual range of parallax values.

17. The apparatus of claim 14, wherein the processor executes the instructions to generate a parallax map based on the conversion characteristic, the display condition being adjusted based on the parallax map.

18. The apparatus of claim 14, wherein the processor executes the instructions to generate a parallax map based on the conversion characteristic, the parallax map identifying a pixel of the image which has an incorrect parallax, and wherein adjusting display condition comprises correcting a parallax of the identified pixel.

19. The apparatus of claim 14, wherein the processor executes the instructions to adjust the display condition of the image by generating an adjusted right-eye image and an adjusted left-eye image based on a parallax map.

20. A non-transitory computer-readable storage medium comprising instructions, which when executed on a processor, cause the processor to perform a method for adjusting display of a three-dimensional image, the method comprising:
receiving a viewing condition associated with an image being viewed by a user;
determining a conversion characteristic based on the viewing condition; and
adjusting a display condition of the image based on the conversion characteristic.
